(19) United States
(12) Patent Application Publication
(10) Pub. No.: US 2018/0347706 A1
(43) Pub. Date: Dec. 6, 2018

(54) Shaft Sealing Device

(71) Applicant: FUTABA INDUSTRIAL CO., LTD., Aichi (JP)

(72) Inventors: Hiromi Ishikawa, Aichi (JP); Naohiro Takemoto, Aichi (JP)

(21) Appl. No.: 15/761,627

(22) PCT Filed: Feb. 15, 2016
(86) PCT No.: PCT/JP2016/054336

§ 371 Date: Mar. 20, 2018

(51) Int. Cl. F16K 1/20; F16K 41/08

(52) U.S. Cl. CPC F16K 1/20; F16K 41/08

(57) ABSTRACT

A shaft sealing device according to one aspect of the present disclosure includes a flow passage pipe, a rotating portion, a valve, a shaft seal, and a flow passage seal. The flow passage pipe includes a gas flow passage therein, and a through hole that communicates an interior of the flow passage with an exterior of the flow passage. The rotating portion is inserted into and held in the through hole, and rotates about a rotation axis that is preset. The valve opens and closes at least one portion of the flow passage in accordance with rotation of the rotating portion. The shaft seal is arranged along an outer circumference of the rotating portion and protrudes therefrom. The flow passage seal is arranged between the flow passage pipe and the rotating portion, and surrounds the rotating portion to have a linear contact with the shaft seal.

### TECHNICAL FIELD

The present disclosure relates to a technique for reducing gas leakage through a rotating shaft.

### BACKGROUND ART

The following Patent Document 1 discloses a shaft sealing device that inhibits gas leakage by providing a surface contact between a member provided to a shaft and a member provided in a side at an exhaust pipe.

### PRIOR ART DOCUMENTS

### Patent Documents

Patent Document 1: Japanese Patent No. 5345708

### SUMMARY OF THE INVENTION

### Problems to be Solved by the Invention

However, the aforementioned shaft sealing device brings the members in contact with each other by the surface contact, which results in difficulty to provide an even contact between the members and thereby to reduce gas leakage.

In one aspect of the present disclosure, it is desirable to surely enable the shaft sealing device to reduce gas leakage that occurs through the rotating shaft.

### Means for Solving the Problems

The shaft sealing device according to one aspect of the present disclosure comprises a flow passage pipe, a rotating portion, a valve, a shaft seal, and a flow passage seal.

The flow passage pipe comprises a gas flow passage therein, and a through hole that communicates the flow passage with an exterior of the flow passage. The rotating portion is inserted into and held in the through hole, and rotates about a rotation axis that is preset. The valve opens and closes at least one portion of the flow passage in accordance with rotation of the rotating portion. The shaft seal is arranged along an outer circumference of the rotating portion and protrudes therefrom. The flow passage seal is arranged between the flow passage pipe and the rotating portion and surrounds the rotating portion to have a linear contact with respect to the shaft seal.

The shaft sealing device as mentioned above provides the linear contact between the shaft seal and the flow passage seal, enabling the shaft seal and the flow passage seal to easily, more evenly come in contact with each other, than in the case of providing a surface contact therebetween. Thus, the shaft sealing device enables reduction in gas leakage from the flow passage to the exterior of the flow passage.

In addition, the shaft sealing device according to one aspect of the present disclosure may comprise a biasing member that is configured to bias the shaft seal against the flow passage seal.

The shaft sealing device as mentioned above enables biasing of the shaft seal against the flow passage seal, thereby enabling increase in contact pressure between the shaft seal and the flow passage seal. Thus, the shaft sealing device enables reduction in the gas leakage from the flow passage seal to the exterior of the flow passage.

In the shaft sealing device according to one aspect of the present disclosure, the biasing member may bias the shaft seal against the flow passage seal and hold the valve in a preset position.

The shaft sealing device as mentioned above enables the biasing member to function to bias the shaft seal against the flow passage seal and to hold the valve in the preset position, thereby requiring less space in comparison with providing the biasing member for every function.

In the shaft sealing device according to one aspect of the present disclosure, when a virtual plane of the shaft sealing device crosses the shaft sealing device along the rotation axis, one of the shaft seal and the flow passage seal may be configured to form a straight line in a contact portion between the shaft seal and the flow passage seal, whereas the other of the shaft seal and the flow passage seal may be configured to form a curved line in the contact portion between the shaft seal and the flow passage seal.

The shaft sealing device as mentioned above ensures that the shaft seal and the flow passage seal enable the linear contact with each other.

In the shaft sealing device according to one aspect of the present disclosure, when the virtual plane of the shaft sealing device crosses the shaft sealing device along the rotation axis, the contact portion in the shaft seal and the contact portion in the flow passage seal may be configured to form respective curved lines.

The shaft sealing device as mentioned above ensures that the shaft seal and the flow passage seal enables the linear contact with each other.

In the shaft sealing device according to one aspect of the present disclosure, when the virtual plane of the shaft sealing device crosses the shaft sealing device along the rotation axis, the shaft seal and the flow passage seal may comprise contact portions that are positioned in opposing sides across the rotating portion. The shaft seal may bear in respective contact portions respective forces that direct toward the rotation axis or respective forces that direct oppositely with respect to the rotation axis.

The shaft sealing device as mentioned above can function to hold the rotating portion in the fixed position, which enables the flow passage seal to function as a shaft bearing for holding the rotating portion.

### BRIEF DESCRIPTION OF THE DRAWINGS

FIG. 1 is a perspective view showing a configuration of a shaft sealing device.

FIG. 2 is a sectional view of a section II-II in the shaft sealing device.

FIG. 3 is an exploded perspective view of a valve and a valve opening and closing mechanism.

FIG. 4 is a front view of the valve.

FIG. 5 is a sectional view of a section V-V in the valve.

FIG. 6 is an enlarged view of sealing portions in the sectional view of the valve according to one embodiment.

FIG. 7 is a sectional view of a section VII-VII in the shaft sealing device to which a biasing member is not assembled.

FIG. 8 is a sectional view of the shaft sealing device to which the biasing member is assembled.

FIG. 9 is an enlarged view of sealing portions in a sectional view of a valve according to a first modified example.

FIG. 10 is an enlarged view of sealing portions in a sectional view of a valve according to a second modified example.

FIG. 11 is an enlarged view of sealing portions in a sectional view of a valve according to a third modified example.

### EXPLANATION OF REFERENCE NUMERALS

1 . . . shaft sealing device, 2 . . . flow passage pipe, 3 . . . gas flow passage, 4 . . . through hole, 6 . . . valve seat, 10 . . . valve, 12 . . . valve body, 14 . . . rotating portion, 14A . . . leading end, 14B, 14C, 14D, 14E . . . shaft seal, 14F . . . protrusion, 16 . . . first hollow cylindrical portion, 16B, 16C, 16D, 16E . . . flow passage seal, 17 . . . contact portion, 18 . . . second hollow cylindrical portion, 20 . . . valve opening and closing mechanism, 22 . . . engaged member, 22A . . . locking hole, 24 . . . biasing member, 26 . . . holding portion.

### MODE FOR CARRYING OUT THE INVENTION

Hereinafter, an example embodiment of the present disclosure will be described with reference to the drawings.

### 1. First Embodiment

[1-1. Configuration]

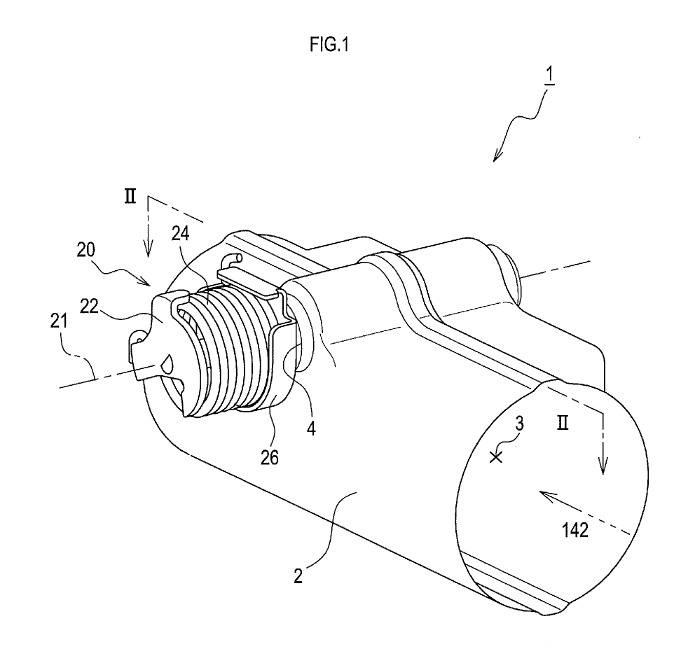

A shaft sealing device 1 shown in FIG. 1 is installed, for example, in a moving object, such as a passenger car and the like, that comprises an internal combustion engine. The shaft sealing device 1 reduces leakage of gas 142, such as exhaust gas and the like, while operating externally of a flow passage pipe 2 a valve 10 that is arranged inside the flow passage pipe 2 where gas 142 flows therethrough from the internal combustion engine.

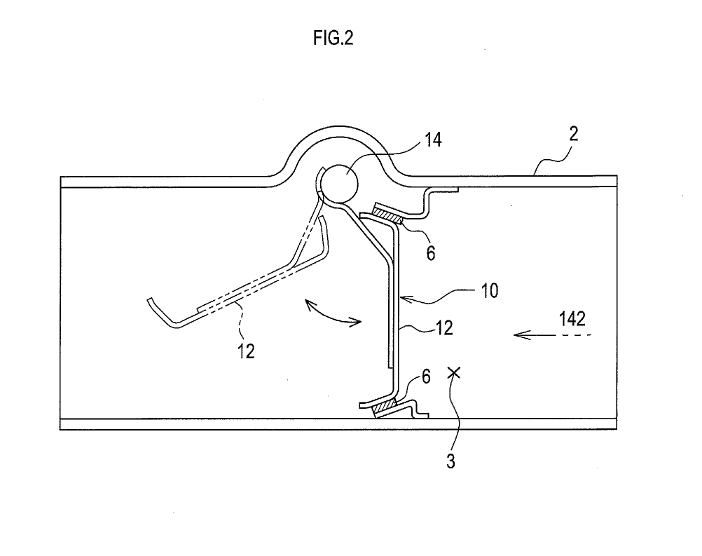

As shown in FIG. 1 and FIG. 2, the shaft sealing device 1 comprises the flow passage pipe 2, the valve 10, and a valve opening and closing mechanism 20. The flow passage pipe 2 has a hollow cylindrical shape with both ends thereof opened to form a gas flow passage 3 for flowing gas therein. The flow passage pipe 2 is coupled to an exhaust pipe, an exhaust manifold, and the like where the gas 142 flows therein from the internal combustion engine. The flow passage pipe 2 arranges a through hole 4 that communicates an interior of the gas flow passage 3 with an exterior of the gas flow passage 3. Note that “communicate” refers to communication between spaces.

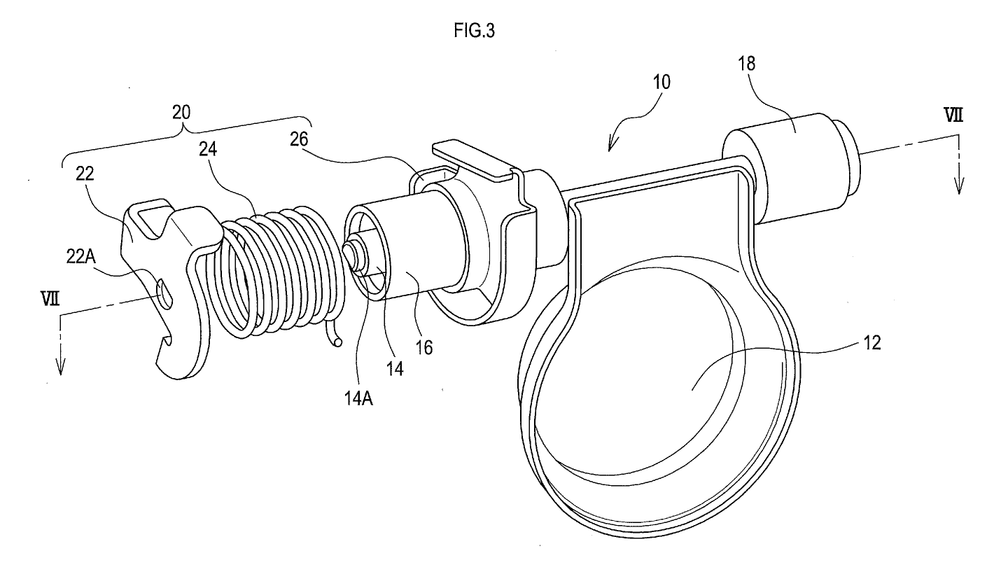

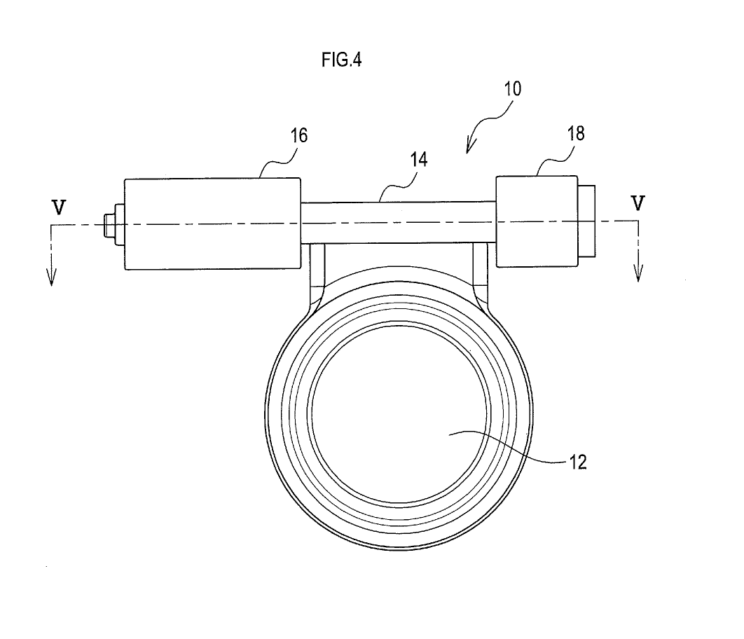

As shown in FIG. 3 and FIG. 4, the valve 10 comprises a valve body 12, a rotating portion 14, a first hollow cylindrical portion 16, and a second hollow cylindrical portion 18.

The valve body 12 opens and closes at least one portion of the gas flow passage 3 and displaces itself in accordance with rotation of the rotating portion 14. The valve body 12 is displaced between a valve closed position where the valve body 12 is in contact with a valve seat 6 that is arranged inside the flow passage pipe 2 and a valve opened position where the valve body 12 is located away from the valve seat 6. In FIG. 2, the valve closed position is indicated by a solid line and the valve opened position is indicated by a broken line.

The rotating portion 14 is a solid cylindrical member that is inserted into and held in the through hole 4, and rotates about a preset rotation axis 21.

As shown in FIG. 3 to FIG. 5, the first hollow cylindrical portion 16 has a hollow cylindrical shape with both ends thereof opened to insert the rotating portion 14 therethrough. Note that “insert through” refers that a member is inserted into a through hole with its leading end protruding from the through hole. The first hollow cylindrical portion 16 holds the rotating portion 14, which is inserted therethrough, in a portion of the rotating portion 14 that is located closer to the through hole 4 than to the valve body 12. In addition, the first hollow cylindrical portion 16 is configured such that an outer circumference of the first hollow cylindrical portion 16 is tightly joined with an inner circumference of the through hole 4.

As shown in FIG. 3 to FIG. 5, the second hollow cylindrical portion 18 has a hollow cylindrical shape with both ends thereof opened to insert the rotating portion 14 therethrough. The second hollow cylindrical portion 18 is held inside the flow passage pipe 2. Accordingly, in the flow passage pipe 2, the rotating portion 14 is configured such that only one end of the rotating portion 14 is exposed outside the flow passage pipe 2, whereas the other end of the rotating portion 14 is held inside the flow passage pipe 2 without being exposed outside the flow passage pipe 2.

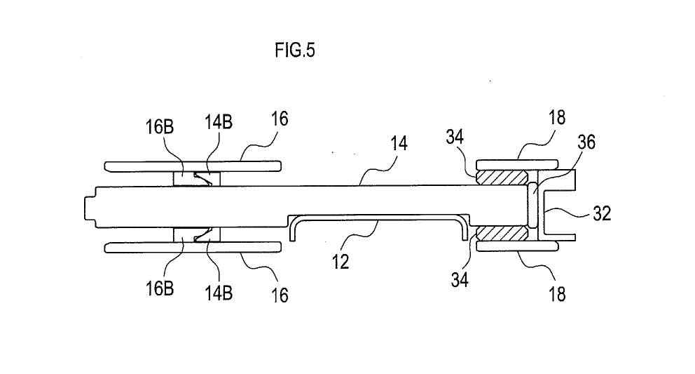

The second hollow cylindrical portion 18 functions as a shaft bearing that rotatably holds the rotating portion 14. Accordingly, as shown in FIG. 5, the second hollow cylindrical portion 18 comprises a blocking member 32, a shaft support 34, and a shaft seat 36.

The blocking member 32 blocks one end of the second hollow cylindrical portion 18 that is opposite to the first hollow cylindrical portion 16. Specifically, the blocking member 32 has the outer diameter that substantially corresponds to the inner diameter of the second hollow cylindrical portion 18, and is fixed to the second hollow cylindrical portion 18 with at least a portion of the blocking member 32 being inserted into the second hollow cylindrical portion 18.

The shaft support 34 is arranged along an outer circumference of the rotating portion 14 and configured as a known shaft bearing that rotatably supports the rotating portion 14. The shaft support 34 can comprise any configurations such as a known bearing and the like.

The shaft seat 36 is fixed to the blocking member 32 and coaxially arranged with the rotation axis 21 of the rotating portion 14. The shaft seat 36 includes, for example, a metal material that is polished to reduce friction and is in contact with an end in the rotating portion 14 that is closer to the blocking member 32 to thereby inhibits the rotating portion 14 from moving toward the blocking member 32. In a configuration where the shaft sealing device 1 comprises a biasing member 24, since the rotating portion 14 is biased in a direction departing from the blocking member 32, the shaft seat 36 may not be included. On the other hand, in a configuration where the shaft sealing device 1 does not comprise the biasing member 24, there is an increasing possibility that the rotating portion 14 may move in any directions along the rotation axis 21. Thus, it is desirable to provide the shaft seat 36.

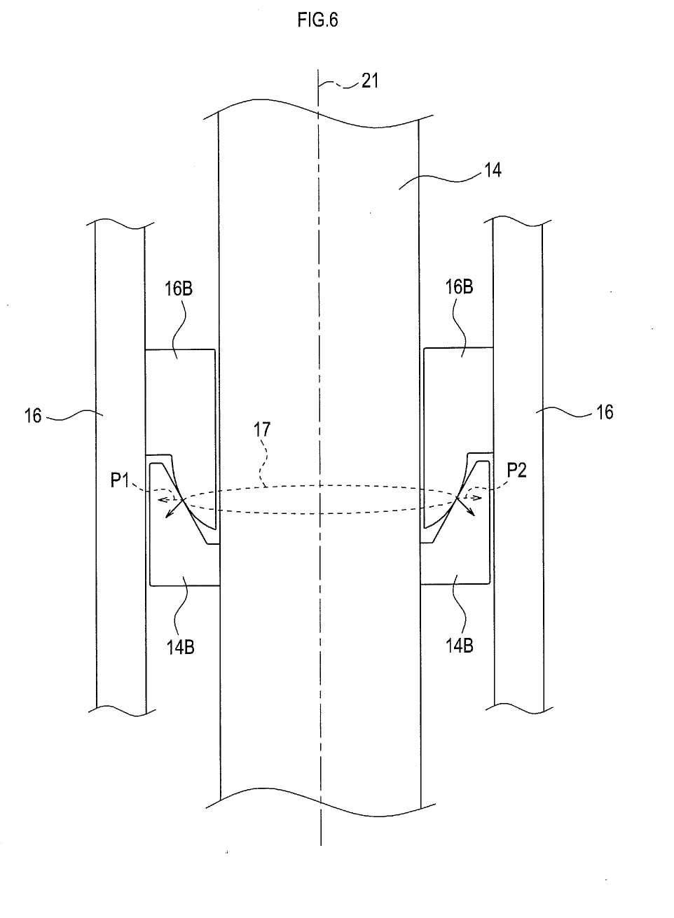

The flow passage pipe 2 is configured to position the through hole 4 to enable rotation of the rotating portion 14 externally of the flow passage pipe 2. Consequently, this requires an effort to reduce the gas, which flows through the flow passage pipe 2, to leak through a gap between the first hollow cylindrical portion 16 and the rotating portion 14. According to the present embodiment, as shown in FIG. 5 and FIG. 6, there is provided a shaft seal 14B on the rotating portion 14 and a flow passage seal 16B, which protrudes inwardly, along an inner circumference of the first hollow cylindrical portion 16. The shaft seal 14B is arranged along the outer circumference of the rotating portion 14 and protrudes therefrom.

The flow passage seal 16B is arranged in the flow passage pipe 2 and surrounds the rotating portion 14 to have a linear contact with the shaft seal 14B at a contact portion 17. The contact portion 17 refers to a contact portion between the flow passage seal 16B and the shaft seal 14B. The contact portion 17 is configured to have a circular or an oval shape.

As shown in FIG. 5 and FIG. 6, the shaft seal 14B and the flow passage seal 16B are configured such that, for example, when an appropriately selected virtual plane of the shaft sealing device 1 crosses thereof along the rotation axis 21 of the rotating portion 14, the shaft seal 14B forms a linear contact surface that includes the contact portion 17 in the shaft seal 14B, whereas the flow passage seal 16B forms a curved contact surface that includes the contact portion 17 in the flow passage 16B. Further, the shaft seal 14B is configured such that the contact portion 17 in the shaft seal 14B faces inward the rotation axis 21 of the rotating portion 14, whereas the flow passage seal 16B is configured such that the contact portion 17 in the flow passage seal 16B faces outward the rotation axis of the rotating portion 14.

As shown in FIG. 6, in the virtual plane of the shaft sealing device 1 that crosses thereof along the rotation axis 21 of the rotating portion 14, the contact portion 17 in the shaft seal 14B is positioned in opposing sides across the rotating portion 14. In the drawing, the shaft seal 14B bears in respective contact portions 17 force P1 and force P2 that direct oppositely with respect to the rotation axis 21 of the rotating portion 14. Accordingly, the rotating portion 14 is positioned and held in the center, where a distance from a central axis of the rotating portion 14 to the respective contact portions 17 is the same, such that the rotating portion 14 evenly bears in the respective contact portions 17 the force P1 and the force P2. In the shaft sealing device 1, such action enables the flow passage seal 16B to function as a shaft bearing of the rotating portion 14.

As shown in FIG. 3, the valve opening and closing mechanism 20 comprises an engaged member 22, the biasing member 24, and a holding portion 26.

The engaged member 22 includes a locking hole 22A formed therein. The locking hole 22A receives a leading end 14A of the rotating portion 14, which is a valve stem, and locks the leading end 14A. The engaged member 22 is rotated by a driving device, such as a motor, a thermal actuator, and the like, that is arranged outside the flow passage pipe 2 to thereby rotate the rotating portion 14 and operate the valve body 12.

The holding portion 26 includes a metal material and holds an end of the biasing member 24 on the valve 10-side to inhibit displacement of the valve 10-side end of the biasing member 24.

The biasing member 24 is configured, for example, as a torsion coil spring. In the valve 10-side end, the biasing member 24 is held in the holding portion 26, whereas in the opposite end, the biasing member 24 is coupled to the engaged member 22. Further, the end of the biasing member 24, which is coupled to the engaged member 22, is displaced in accordance with the rotation of the engaged member 22. According to such configuration, when the valve body 12 is displaced from a preset position, the biasing member 24 biases the valve body 12 to return to the preset position.

Consequently, the biasing member 24 acts to hold the valve body 12 of the valve 10 in the preset position. Note that the preset position refers to, for example, an opened position of the valve body 12, a closed position of the valve body 12, and the like. Particularly, in the present embodiment, the biasing member 24 is attached so as to bias the valve body 12 in a valve closing direction of the valve body 12.

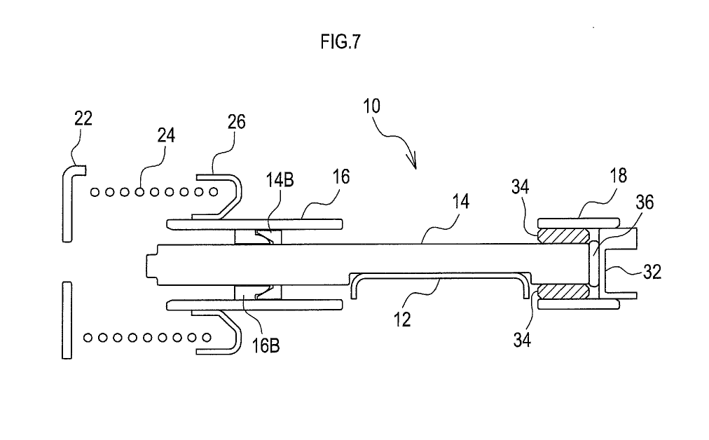

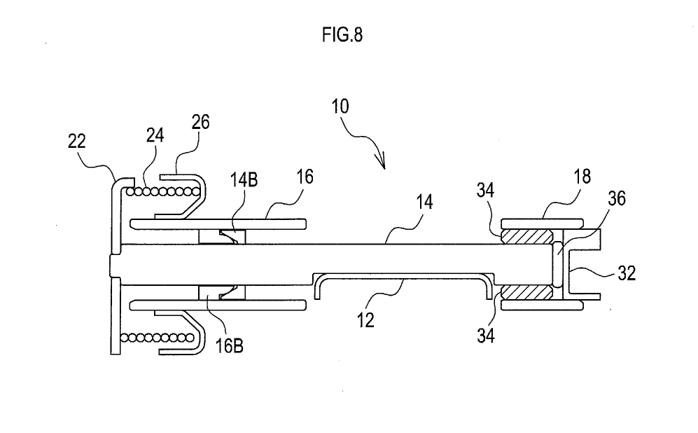

As shown in FIG. 3 and FIG. 7, the biasing member 24 is configured such that spaces between steel courses of a coil, which configure the torsion coil spring, become greater when an external force does not act on the basing member 24. As shown in FIG. 8, when the biasing member 24 is assembled to the rotating portion 14, the external force acts on the biasing member 24 such that the spaces between respective steel courses become smaller. In this case, the biasing member 24 exerts a basing force in a direction that widens the spaces between the respective steel courses. Accordingly, the biasing member 24 exerts the biasing force in a direction where the rotating portion 14 moves toward the engaged member 22. The biasing member 24 increases a force between the flow passage seal 16B and the shaft seal 14B to come in contact with each other in the contact portion 17.

[1-2. Effect]

According to the first embodiment detailed above, the following effect can be obtained.

(1a) The aforementioned shaft sealing device 1 comprises the flow passage pipe 2, the rotating portion 14, the valve 10, the shaft seal 14B, and the flow passage seal 16B.

The flow passage pipe 2 forms the gas flow passage 3 therein for gas and provides the through hole 4 that communicates the interior of the gas flow passage 3 with the exterior of the flow passage 3. The rotating portion 14 is inserted into and held in the through hole 4, and rotates about the preset rotation axis 21. The valve 10 opens and closes the at least one portion of the gas flow passage 3 in accordance with the rotation of the rotating portion 14. The shaft seal 14B is arranged along the outer circumference of the rotating portion 14 and protrudes therefrom. The flow passage seal 16B is arranged between the flow passage pipe 2 and the rotating portion 14, and surrounds the rotating portion 14 to have the linear contact with respect to the shaft seal 14B.

The shaft sealing device 1 as mentioned above provides the linear contact between the shaft seal 14B and the flow passage seal 16B, thereby enabling the shaft seal 14B and the flow passage seal 16B to easily, more evenly come in contact with each other, than in the case of providing a surface contact therebetween. Thus, the shaft sealing device 1 enables reduction in gas leakage from the gas flow passage 3 to the exterior of the gas flow passage 3. In addition, since the shaft sealing device 1 provides the linear contact between the shaft seal 14B and the flow passage seal 16B, this enables reduction in fractional resistance occurred in displacement of the valve 10, in comparison with the case of providing a surface contact therebetween.

(1b) The aforementioned shaft sealing device 1 comprises the biasing member 24 that is configured to bias the shaft seal 14B against the flow passage seal 16B.

The shaft sealing device 1 as mentioned above enables biasing of the shaft seal 14B against the flow passage seal 16B, thereby enabling increase in contact pressure between the shaft seal 14B and the flow passage seal 16B. Thus, the shaft sealing device 1 enables reduction in the gas leakage from the gas flow passage 3 to the exterior of the gas flow passage 3.

(1c) In the aforementioned shaft sealing device 1, the biasing member 24 biases the shaft seal 14B against the flow passage seal 16B and holds the valve 10 in the preset position.

The shaft sealing device 1 as mentioned above enables the biasing member 24 to function to bias the shaft seal 14B against the flow passage seal 16B and to hold the valve 10 in the preset position, thereby requiring less space in comparison with the case of providing the biasing member 24 for every function. In addition, the shaft sealing device 1 also enables reduction in the number of parts, which results in cost reduction, in comparison with the case of providing the biasing member 24 for every function.

(1d) In the aforementioned shaft sealing device 1, when the virtual plane of the shaft sealing device 1 crosses thereof along the rotation axis 21, one of the shaft seal 14B and the flow passage seal 16B is configured to form a straight line in the contact portion 17 between the shaft seal 14B and the flow passage seal 16B, whereas the other of the shaft seal 14B and the flow passage seal 16B is configured to form a curved line in the contact portion 17 between the shaft seal 14B and the flow passage seal 16B.

The shaft sealing device 1 as mentioned above provides, as viewed in a section, a point contact between the straight line and the curved line, thereby ensuring that the shaft seal 14B and the flow passage seal 16B enable the linear contact with each other.

(1e) In the aforementioned shaft sealing device 1, when the virtual plane of the shaft sealing device 1 crosses thereof along the rotation axis 21, the shaft seal 14B and the flow passage seal 16B comprise contact portions that are positioned in the opposing sides across the rotating portion 14. The shaft seal 14B bears in the respective contact portions respective forces that direct toward the rotation axis 21 or respective forces that direct oppositely with respect to the rotation axis 21.

The shaft sealing device 1 as mentioned above can function to hold the rotating portion 14 in the fixed position. Accordingly, this enables the flow passage seal 16B to function as the shaft bearing for holding the rotating portion 14.

### 2. Other Embodiments

Accordingly, while the embodiments of the present disclosure have been described, the present disclosure is not limited to the above-described embodiments and can be implemented in various modifications.

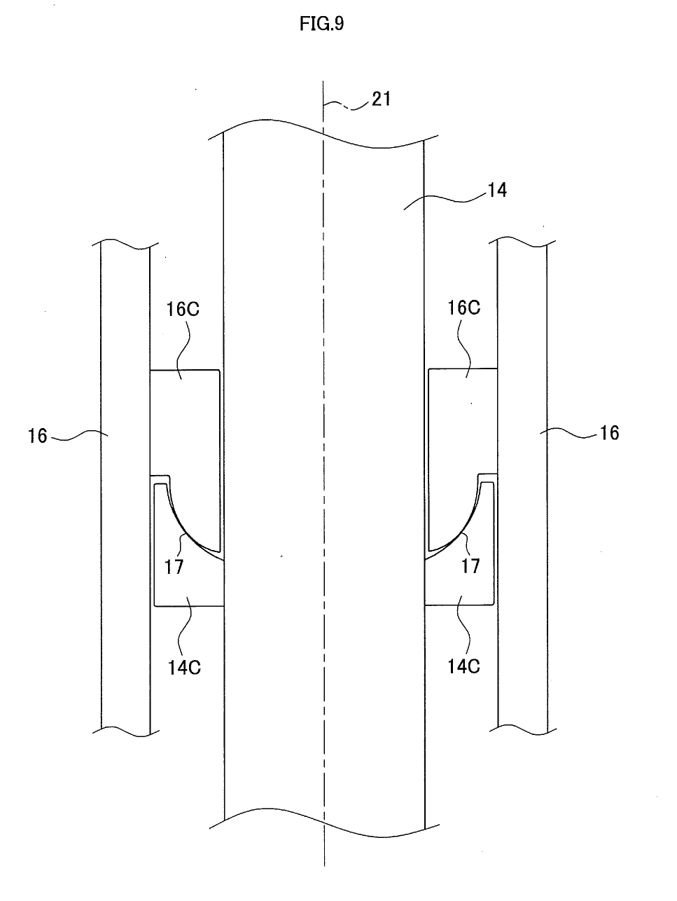

(2a) According to the aforementioned embodiments, when the appropriately selected virtual plane of the shaft sealing device crosses thereof along the rotation axis 21 of the rotating portion 14, the shaft seal 14B is configured to form the linear contact portion in the shaft seal 14B with the flow passage seal 16B, whereas the flow passage seal 16B is configured to form the curved contact portion in the flow passage seal 16B with the shaft seal 14B. However, the configurations of the shaft seal and the flow passage seal are not limited hereto. For example, as shown in FIG. 9, a shaft seal 14C may be configured to form a curved contact portion in the shaft seal 14C with a flow passage seal 16C and the flow passage seal 16C may be configured to form a curved contact portion in the flow passage seal 16C with the shaft seal 14C.

(2b) According to the aforementioned embodiment, when the virtual plane of the shaft sealing device 1 crosses thereof along the rotation axis 21 of the rotating portion 14, the shaft seal 14B is configured to bear in the respective contact portions 17 the respective forces that direct oppositely with respect to the rotation axis 21 of the rotating portion 14. However, the shaft seal 14B may be configured to bear in the respective contact portions 17 respective forces that direct toward the rotation axis 21.

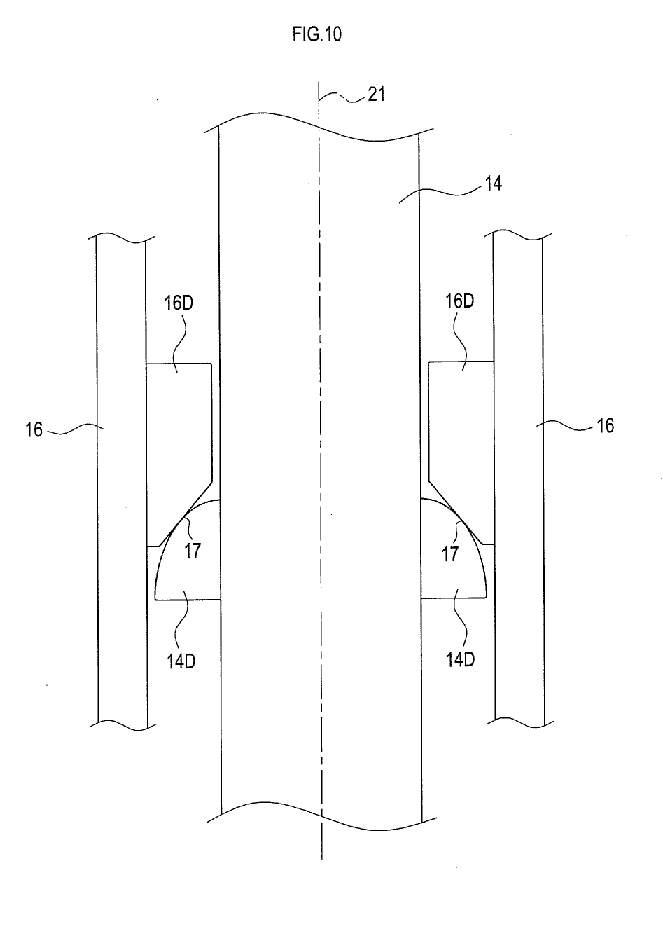

That is, as shown in FIG. 10, a shaft seal 14D is configured to have a contact portion that faces outward away from the rotation axis 21 of the rotating portion 14, whereas a flow passage seal 16D is configured to have a contact portion that faces inward toward the rotation axis 21 of the rotating portion 14.

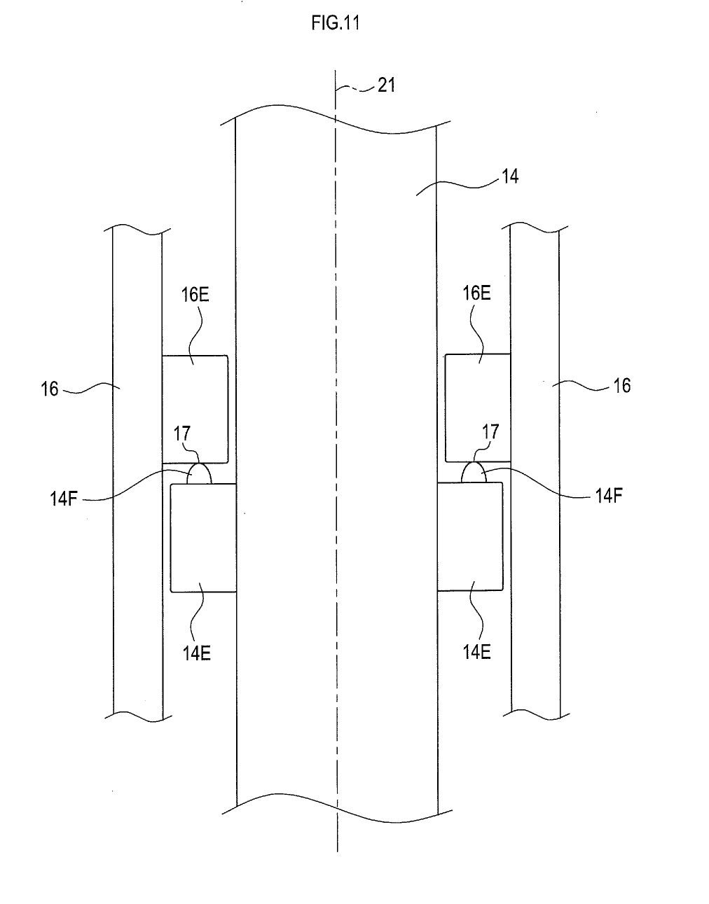

(2c) Further, the flow passage seal and the shaft seal 14B can have appropriately selected respective configurations that can surround the rotating portion 14 to have the linear contact with each other. For example, as shown in FIG. 11, a flow passage seal 14E may be arranged protruding along an outer circumference of the rotating portion 14 and protrudes therefrom, and a flow passage seal 16E may comprise a protrusion 14F that is ring-shaped to surround the rotation axis 21 of the rotating portion 14.

(2d) According to the aforementioned embodiment, the flow passage pipe 2 is configured to flow the exhaust gas therethrough. However, the flow passage pipe 2 may be configured to flow gas other than the exhaust gas therethrough.

The same effect as the effect of (1a) can be obtained according to the aforementioned (2a) to (2d).

(2e) Functions of one element of the aforementioned embodiment may be distributed to plurality of elements. Functions of a plurality of elements may be integrated into one element. Part of the configurations of the above-described embodiments may be omitted. At least part of the configurations of the above-described embodiments may be added to or replaced with the configurations of the other above-described embodiments. Any embodiment included in the technical ideas defined by the language of the claims is an embodiment of the present disclosure.

(2f) The present disclosure can be realized in various modes other than the aforementioned shaft sealing device, such as a system comprising the shaft sealing device as a component, a shaft sealing method, and the like.

1. A shaft sealing device comprising:
a flow passage pipe comprising:
a gas flow passage therein, and
a through hole that communicates an interior of the flow passage with an exterior of the flow passage;
a rotating portion that is configured to be inserted into and held in the through hole and to rotate about a rotation axis that is preset;
a valve that is configured to open and close at least one portion of the flow passage in accordance with rotation of the rotating portion;
a shaft seal that is arranged along an outer circumference of the rotating portion and protrudes therefrom; and
a flow passage seal that is arranged between the flow passage pipe and the rotating portion, and surrounds the rotating portion to have a linear contact with respect to the shaft seal.

2. The shaft sealing device according to claim 1, further comprising
a biasing member that is configured to bias the shaft seal against the flow passage seal.

3. The shaft sealing device according to claim 2,
wherein the biasing member is configured to bias the shaft seal against the flow passage seal and to hold the valve in a preset position.

4. The shaft sealing device according to claim 1,
wherein when a virtual plane of the shaft sealing device crosses the shaft sealing device along the rotation axis, one of the shaft seal and the flow passage seal is configured to form a straight line in a contact portion between the shaft seal and the flow passage seal, whereas the other of the shaft seal and the flow passage seal is configured to form a curved line in the contact portion between the shaft seal and the flow passage seal.

5. The shaft sealing device according to claim 1,
wherein when the virtual plane of the shaft sealing device crosses the shaft sealing device along the rotation axis, the contact portion in the shaft seal and the contact portion in the flow passage seal are configured to form respective curved lines.

6. The shaft sealing device according to claim 1,
wherein when the virtual plane of the shaft sealing device crosses the shaft sealing device along the rotation axis, the shaft seal and the flow passage seal comprise contact portions that are positioned in opposing sides across the rotating portion, and
wherein the shaft seal is configured to bear in respective contact portions respective forces that direct toward the rotation axis or respective forces that direct oppositely with respect to the rotation axis.

7. The shaft sealing device according to claim 2,
wherein when a virtual plane of the shaft sealing device crosses the shaft sealing device along the rotation axis, one of the shaft seal and the flow passage seal is configured to form a straight line in a contact portion between the shaft seal and the flow passage seal, whereas the other of the shaft seal and the flow passage seal is configured to form a curved line in the contact portion between the shaft seal and the flow passage seal.

8. The shaft sealing device according to claim 3,
wherein when a virtual plane of the shaft sealing device crosses the shaft sealing device along the rotation axis, one of the shaft seal and the flow passage seal is configured to form a straight line in a contact portion between the shaft seal and the flow passage seal, whereas the other of the shaft seal and the flow passage seal is configured to form a curved line in the contact portion between the shaft seal and the flow passage seal.

9. The shaft sealing device according to claim 2,
wherein when the virtual plane of the shaft sealing device crosses the shaft sealing device along the rotation axis, the contact portion in the shaft seal and the contact portion in the flow passage seal are configured to form respective curved lines.

10. The shaft sealing device according to claim 3,
wherein when the virtual plane of the shaft sealing device crosses the shaft sealing device along the rotation axis, the contact portion in the shaft seal and the contact portion in the flow passage seal are configured to form respective curved lines.

11. The shaft sealing device according to claim 2,
wherein when the virtual plane of the shaft sealing device crosses the shaft sealing device along the rotation axis, the shaft seal and the flow passage seal comprise contact portions that are positioned in opposing sides across the rotating portion, and
wherein the shaft seal is configured to bear in respective contact portions respective forces that direct toward the rotation axis or respective forces that direct oppositely with respect to the rotation axis.

12. The shaft sealing device according to claim 3,
wherein when the virtual plane of the shaft sealing device crosses the shaft sealing device along the rotation axis, the shaft seal and the flow passage seal comprise contact portions that are positioned in opposing sides across the rotating portion, and
wherein the shaft seal is configured to bear in respective contact portions respective forces that direct toward the rotation axis or respective forces that direct oppositely with respect to the rotation axis.

13. The shaft sealing device according to claim 4,
wherein when the virtual plane of the shaft sealing device crosses the shaft sealing device along the rotation axis, the shaft seal and the flow passage seal comprise contact portions that are positioned in opposing sides across the rotating portion, and
wherein the shaft seal is configured to bear in respective contact portions respective forces that direct toward the rotation axis or respective forces that direct oppositely with respect to the rotation axis.

14. The shaft sealing device according to claim 5,
wherein when the virtual plane of the shaft sealing device crosses the shaft sealing device along the rotation axis, the shaft seal and the flow passage seal comprise contact portions that are positioned in opposing sides across the rotating portion, and
wherein the shaft seal is configured to bear in respective contact portions respective forces that direct toward the rotation axis or respective forces that direct oppositely with respect to the rotation axis.

15. The shaft sealing device according to claim 7,
wherein when the virtual plane of the shaft sealing device crosses the shaft sealing device along the rotation axis, the shaft seal and the flow passage seal comprise contact portions that are positioned in opposing sides across the rotating portion, and
wherein the shaft seal is configured to bear in respective contact portions respective forces that direct toward the rotation axis or respective forces that direct oppositely with respect to the rotation axis.

16. The shaft sealing device according to claim 8,
wherein when the virtual plane of the shaft sealing device crosses the shaft sealing device along the rotation axis, the shaft seal and the flow passage seal comprise contact portions that are positioned in opposing sides across the rotating portion, and
wherein the shaft seal is configured to bear in respective contact portions respective forces that direct toward the rotation axis or respective forces that direct oppositely with respect to the rotation axis.

17. The shaft sealing device according to claim 9,
wherein when the virtual plane of the shaft sealing device crosses the shaft sealing device along the rotation axis, the shaft seal and the flow passage seal comprise contact portions that are positioned in opposing sides across the rotating portion, and
wherein the shaft seal is configured to bear in respective contact portions respective forces that direct toward the rotation axis or respective forces that direct oppositely with respect to the rotation axis.

18. The shaft sealing device according to claim 10,
wherein when the virtual plane of the shaft sealing device crosses the shaft sealing device along the rotation axis, the shaft seal and the flow passage seal comprise contact portions that are positioned in opposing sides across the rotating portion, and
wherein the shaft seal is configured to bear in respective contact portions respective forces that direct toward the rotation axis or respective forces that direct oppositely with respect to the rotation axis.
